(19) United States
(12) Patent Application Publication
(10) Pub. No.: US 2011/0129094 A1
(43) Pub. Date: Jun. 2, 2011

(54) CONTROL OF OPERATING PARAMETERS IN A BINAURAL LISTENING SYSTEM

(75) Inventor: Peter PETERSEN, Smoerum (DK)

(73) Assignee: OTICON A/S, Smoerum (DK)

(21) Appl. No.: 12/957,774

(22) Filed: Dec. 1, 2010

Related U.S. Application Data
(60) Provisional application No. 61/265,375, filed on Dec. 1, 2009.

(30) Foreign Application Priority Data
Dec. 1, 2009 (EP) 09177630.2

(51) Int. Cl. H04R 5/00

(52) U.S. Cl. 381/23.1

(57) ABSTRACT

The application relates to a binaural listening system comprising first and second listening devices adapted for being located at or in left and right ears, respectively, of a person during use of the listening system, each listening device comprising antenna and transceiver circuitry for establishing a bidirectional wireless link to the opposite listening device during use of the system, each listening device comprising a manually operable activation element for influencing the functionality of the listening system in a predefined way, the manually operable activation element having at least one mode of operation. The application further relates to use of binaural listening system and to a method of operating a binaural listening system. The object of the present application is to provide a scheme for enabling a user input in a binaural listening system. The problem is solved in that the system is adapted to provide that the effect on functionality of a specific activation of the manually operable activation element of the first listening device is different from the effect of the same specific activation of the corresponding manually operable activation element of the second listening device. This has the advantage of enabling a scheme for setting operating parameters of the system with a minimum of activators. The invention may e.g. be used for the where listening devices are used at both ears of a user, e.g. hearing instruments, head phones, active ear protection devices, etc.

### TECHNICAL FIELD

The present application relates to listening systems, e.g. hearing aid systems, in a binaural setup, i.e. comprising two listening devices, e.g. hearing instruments, adapted to stimulate a user's left and right ear, respectively. The disclosure relates specifically to the control of operating parameters (e.g. the volume of sound presented to the user) in the two cooperating devices of a binaural listening system. The application furthermore relates to the use of a binaural listening system and to a method of operating a binaural listening system.

The disclosure may e.g. be useful in applications where listening devices are used at both ears of a user, e.g. hearing instruments, head phones, active ear protection devices, etc.

### BACKGROUND ART

The following account of the prior art relates to one of the areas of application of the present application, volume regulation in binaural hearing aid systems.

In hearing instruments comprising two user accessible push buttons, the volume level can e.g. be adjusted individually for each instrument (be it a monaural or a binaural fitting). The function chosen on a first instrument can e.g. be automatically transferred to the second instrument via a wireless interface between them, cf. e.g. US 2004/0208332 A1 or WO 2008/006772 A2 or EP 0 941 014 A2.

### DISCLOSURE OF INVENTION

Hearing instruments are becoming increasingly small in size and at the same time provide an increasing amount of functionalities, which to a certain extent or in some instances require a user input. A problem with miniaturization of hearing instruments is that the space available for a user interface directly on the hearing instrument is also decreasing. It can be difficult find space for more than one activation element. It can further be difficult to implement a user interface that allows a multitude of different user inputs to be delivered using the same activation element (e.g. up/down regulations of volume). An object of the present application is to provide a scheme for enabling a user input in a binaural listening system. It is a further object to enable a user input in a binaural listening system comprising relatively small hearing instruments. It is a specific object to provide a scheme for regulating volume in a binaural listening system.

Objects of the application are achieved by the invention described in the accompanying claims and as described in the following.

An object of the application is achieved by a binaural listening system comprising first and second listening devices adapted for being located at or in left and right ears, respectively, of a person during use of the listening system, each listening device comprising antenna and transceiver circuitry for establishing a bidirectional wireless link to the opposite listening device during use of the system, each listening device comprising a manually operable activation element for influencing the functionality of the listening system in a predefined way, the manually operable activation element having at least one mode of operation, wherein the system is adapted to provide that the effect on functionality of a specific activation of the manually operable activation element of the first listening device is different from the effect of the same specific activation of the corresponding manually operable activation element of the second listening device.

This has the advantage of enabling a scheme for setting operating parameters of the system with a minimum of activators. It further has the advantage of facilitating the use of relatively small activators and relatively small instruments. The term ‘relatively small instruments’ is in the present context taken to mean instruments having a maximum physical extension in the order of cm, such as a few cm, e.g. smaller than 3 cm, such as smaller than 2 cm.

The term ‘influencing the functionality’ is in the present context e.g. taken to mean changing one or more operational parameters of the listening device, e.g. related to its output sound level (volume), the microphone system (directionality), program selection, etc.

The term ‘the effect on functionality’ is in the present context e.g. taken to mean the effect of a given activation providing e.g. a change of a program (or a parameter of a program), e.g. to increase speech intelligibility in a given acoustic environment, or to improve the comfort in listening to music, the change of the volume, the change of compression, the change of the anti-feedback behaviour of the device, the change om directionality of the microphone system, the change of the input being taken from one input transducer to another (e.g. from a microphone system to a wireless input, e.g. telecoil), etc.

The term ‘specific activation’ is intended to refer to how the manually operable activation element is activated by a user. In case there is a scheme for different modes of operation of the activation element according to its specific activation (e.g. action dependent on time of activation of the activation element or on frequency of operation (e.g. ‘double-click’), etc., the effects that are compared (and different) are supposed to be the result of the same ‘specific activation’ in the same mode of operation of the activation element.

In an embodiment, a control signal representing (or adapted to initiate) a modification of the current setting of the listening device to provide the effect of (i.e. generated by) the activation of the activation element of the first listening device is transferred via the wireless link to the second listening device for implementing the same effect in that listening device and vice versa (‘vice versa’ here meaning that a control signal generated by the activation of the activation element on the second listening device is transferred to the first listening device). This has the advantage that the parameter setting modified on one device is automatically transferred to the other device, so that the modification is synchronized.

In an embodiment, the binaural listening system is adapted to provide that the manually operable activation element has at least two modes of operation, e.g. two or more, where each mode of operation influences a different part of the functionality of the listening system, each mode being e.g. limited to modify only a specific predefined subset of operational parameters of the listening device. Different parts of the functionality can e.g. be volume setting, program selection, on-off setting (low power/full power setting), directional<->non-directional, wireless<->microphone input, etc.

In the present context, the term ‘mode of operation’ in connection with the ‘manually operable activation element’ is intended to define a configuration where the system is adapted to provide that the activation element can only influence a specific (predefined) part of the functionality of the binaural listening system, e.g. ‘program selection’, ‘volume control’, ‘input transducer selection’, ‘directionality control’, etc. In an embodiment, in case an activation element of the first listening device has only one mode of operation, the system is adapted to provide that that mode—at least at a given point in time—is different from a mode of operation of the second listening device.

In an embodiment, the system is adapted to provide that the activation elements of the listening devices are in different modes of operation at a given point in time, e.g. the activation element of one of the listening devices being associated with program selection, while the activation element of the other listening device is associated with selection between an input transducer and a direct electric input. The activation of a given activation element on a given device results in the modification in question being automatically transferred to the other device via the wireless link. This comprises a scheme for providing a multitude of optional user modifications to the operational state of the system using only one activation element on each device of a binaural listening system.

Preferably, the system is adapted to provide that the activation elements of the listening devices of the system are or can be set in the same mode of operation at a given point in time. In an embodiment, the system is adapted to provide that the activation elements of the two listening devices are in the same mode of operation after a start-up (e.g. after having been powered down). However, preferably, the system is adapted to provide that the activation elements of the two listening devices are in different modes of operation after a start-up (e.g. after having been powered down).

In a particular embodiment, the system is adapted to provide that the effect on functionality of a specific activation of the manually operable activation element of the first listening device in a given mode of operation of the manually operable activation element is different from the effect of the same specific activation of the corresponding manually operable activation element of the second listening device in the same given mode of operation of the manually operable activation element.

In an embodiment, the functionalities activated by the manually operated activation element of the first (e.g. right) listening device are associated with an increase (e.g. more of a given effect, e.g. more noise reduction, more directionality, more volume, etc.), whereas functionalities activated by the activation element of the second (e.g. left) listening device are associated with a (corresponding) decrease.

In an embodiment, the binaural listening system is adapted to provide that the manually operable activation element in a mode of operation changes the volume setting, e.g. increases or decreases the volume (resulting in an increased or decreased perceived sound pressure level of the user). In an embodiment, the only mode of operation of the manually operable activation element is to influence the volume setting of the listening devices of the system.

To enable e.g. volume control in a binaural listening system comprising first and second listening devices adapted for being located in or at a left and right ear of a user, where each listening device (LD) of the system has e.g. a single user-accessible activator (e.g. a push button (PB)), a wireless link between the listening devices is used to transfer an activator input from the user operable activation element on one listening device to the other listening device. A regulation scheme can for example be implemented so that an activator input (e.g. a PB click) on a right LD results in a volume-up command being generated and transferred to a left LD and a consequent increase in volume in both listening devices, whereas an activator input (e.g. a PB click) on the left LD results in a volume-down command being generated and transferred to the right LD and a consequent decrease in volume in both listening devices.

In an embodiment, volume is regulated in a number Np of predefined steps between a minimum level and a maximum level. In an embodiment, the steps are of equal size. In an embodiment, the system is adapted to provide that the steps are larger when a decrease is requested by a user than when an increase is requested by the user. In an embodiment, the down-steps are progressively lower from a largest first step from the maximum level to a smallest last step to the minimum level. In an embodiment, only the step from the maximum level and down is larger than the other down-steps. In an embodiment, the first two steps down from the maximum level are larger than the other down-steps. In an embodiment, the system is adapted to provide that a repeated activation of the activation elements attempting to increase or decrease, respectively, the volume when a maximum or minimum level, respectively, has already been reached has no effect. In an embodiment, the system is adapted to provide an acoustic or tactile indication to the user when such ineffective activation is performed.

In an embodiment, the binaural listening system is adapted to provide that the manually operable activation element in a mode of operation changes the program setting, a given program setting defining a parameter setting optimized for a specific listening situation of the binaural listening system. In an embodiment, the effect of activation of the manually operable activation element of one of the listening devices is to select the next listening program for both listening devices and the effect of activation of the manually operable activation element of the other listening device is to select the previous listening program for both listening devices. This can e.g. be attractive in a situation where the different available programs of the listening device are arranged in a cyclic list.

In an embodiment, the manually operable activation element is an activation element that requires a user to touch a specific area of a surface (e.g. push a button, touch a touch sensitive element or part of a a surface, rotate a wheel, etc.). In an embodiment, the manually operable activation element is an activation element that can be activated without physical contact to a surface (e.g. via a capacitive or magnetic or other electromagnetic coupling).

In an embodiment, the binaural listening system is adapted to provide that different modes of operation of the manually operable activation element can be selected by activating the manually operable activation element for different durations of time, e.g. relatively short and relatively long durations of time. In an embodiment, the mode of operation and/or the change of mode of operation of the manually operable activation element is/are communicated to the user by an acoustic or tactile indicator, when the activation element is operated. The tactile indication can e.g. be communicated to the user via the activation element (e.g. a push button). Alternatively, the tactile indication can e.g. be communicated to the user via another part (e.g. the housing) of the listening device. The acoustic indicator is preferably communicated to the user via one or more output transducer(s) of the listening devices.

In an embodiment, the binaural listening system is adapted to provide that the different modes of operation of the manually operable activation element and/or the effects of activation of the manually operable activation element in a given manner in a given mode on the individual hearing instruments of the binaural listening system can be set during fitting of the system, e.g. according to a particular user's needs and/or wishes.

In an embodiment, a listening device of a binaural listening system comprises a hearing instrument (comprising a frequency dependent gain, e.g. adaptable to a specific user's hearing impairment or to the needs in a specific listening situation), a headphone, an active ear protection device or a combination thereof.

A listening device of a binaural listening system comprises an output transducer (e.g. a receiver, electrodes of a cochlear implant or a vibrator of a bone conduction hearing device) for converting an electric signal to output stimuli that are perceived by a user as an output sound. The listening device further comprises a signal processing unit for processing an electric input signal (e.g. from an input transducer or a direct electrical input, e.g. by applying a frequency dependent gain to the input signal) and providing a processed output signal (e.g. fed to an output transducer). The listening device further comprises transceiver circuitry for establishing a wireless interface for exchanging (at least) control signals with another (corresponding) listening device of the binaural listening system. In an embodiment, the listening device also comprises a direct electric input, e.g. established by transceiver circuitry for receiving audio signals from an ‘external’ audio delivery device. The listening device further comprises a user operable activation element, e.g. a push button or any other activating activation element known in the art, for influencing the functionality of the system. In an embodiment, the listening device contains a single user operable activation element. In an embodiment, the system is adapted to provide that the user operable activation element can influence the level of the output stimuli (e.g. the perceived volume or level of a sound) presented to the user via the output transducer. In an embodiment, a listening device of a binaural listening system comprises an input transducer (e.g. a microphone or a microphone system) for picking up a sound from the environment and converting it to an electric signal.

Use of a binaural listening system as described above, in the detailed description of ‘mode(s) for carrying out the invention’ and in the claims is furthermore provided by the present application. Use of a binaural listening system in a binaural hearing aid system comprising left and right hearing instruments, the hearing instruments being e.g. adapted to a specific user's needs as regards frequency dependent gain and/or compression and/or noise reduction, and/or directionality, etc. is provided.

A method of operating a binaural listening system, the binaural listening system comprising first and second listening devices adapted for being located at or in left and right ears, respectively, of a person during use of the listening system, each listening device comprising antenna and transceiver circuitry for establishing a bidirectional wireless link with the opposite listening device during use of the system, each listening device comprising a manually operable activation element for influencing the functionality of the listening system in a predefined way, the manually operable activation element having at least one mode of operation is moreover provided by the present application. The method comprises providing that the effect on functionality of a specific activation of the manually operable activation element of the first listening device is different from the effect of the same specific activation of the corresponding manually operable activation element of the second listening device.

It is intended that the structural features of the system described above, in the detailed description of ‘mode(s) for carrying out the invention’ and in the claims can be combined with the method, when appropriately substituted by a corresponding process. Embodiments of the method have the same advantages as the corresponding systems.

In an embodiment, the method comprises providing that a control signal representing the effect of the activation of the activation element of the first listening device is transferred via the wireless link to the second listening device for implementing the intended same effect in that listening device and vice versa.

In an embodiment, the method comprises providing that the manually operable activation element has at least two modes of operation, where each mode of operation influences a different part of the functionality of the listening system.

In an embodiment, the method comprises providing that the manually operable activation element in a mode of operation changes the volume setting.

In an embodiment, the method comprises providing that the effect of activation of the manually operable activation element of one of the listening devices is to increase the volume setting of both listening devices and the effect of activation of the manually operable activation element of the other listening device is to decrease the volume setting of both listening devices.

A tangible computer-readable medium storing a computer program comprising program code means for causing a data processing system to perform the steps of the method described above, in the detailed description of ‘mode(s) for carrying out the invention’ and in the claims, when the computer program is executed on the data processing system is furthermore provided by the present application. In addition to being stored on a tangible medium such as diskettes, CD-ROM-, DVD-, or hard disk media, or any other machine readable medium, e.g. a volatile (e.g. RAM) or non-volatile (e.g. NV-RAM, e.g. EPROM) memory the computer program can also be transmitted via a transmission medium such as a wired or wireless link or a network, e.g. the Internet, and loaded into a data processing system for being executed at a location different from that of the tangible medium.

A data processing system comprising a processor and program code means for causing the processor to perform the steps of the method described above, in the detailed description of ‘mode(s) for carrying out the invention’ and in the claims is furthermore provided by the present application.

Further objects of the application are achieved by the embodiments defined in the dependent claims and in the detailed description of the invention.

As used herein, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

### BRIEF DESCRIPTION OF DRAWINGS

The disclosure will be explained more fully below in connection with a preferred embodiment and with reference to the drawings in which:

FIG. 1 shows an exemplary binaural listening system comprising two wirelessly connected listening devices (FIG. 1a) and an exemplary listening device (FIG. 1b), and

FIG. 2 shows examples of a program shift scheme for a binaural listening system (FIG. 2a) and two different schemes for changing volume for a binaural listening system, one with equal steps up and down (FIG. 2b) and one with larger steps down than up (FIG. 2c).

The figures are schematic and simplified for clarity, and they just show details which are essential to the understanding of the disclosure, while other details are left out.

Further scope of applicability of the present disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

### MODE(S) FOR CARRYING OUT THE INVENTION

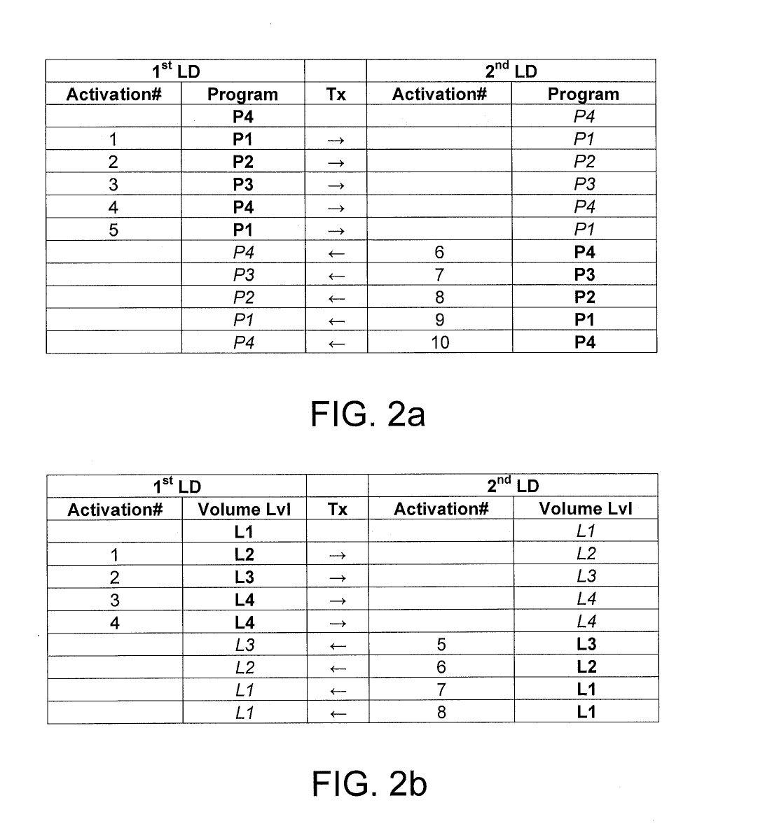

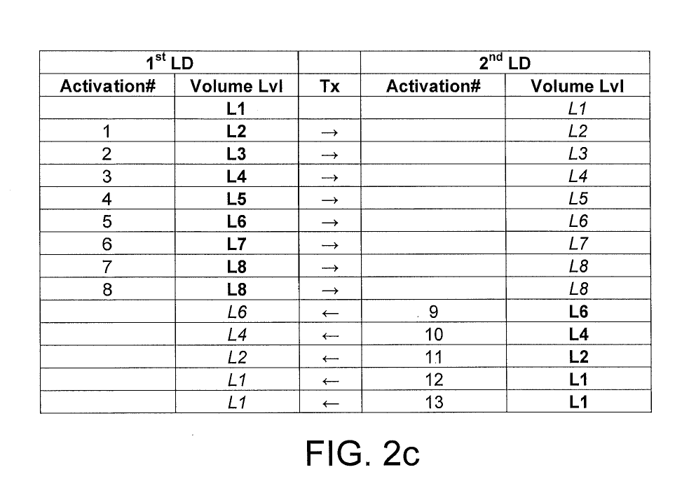

On single push button instruments a functionality similar to that of double button instruments can be obtained using the (wireless) exchange of control signals between two hearing instruments of a binaural fitting to enable e.g. volume control (or other functionality of a binaural listening system). A push button click on the right side instrument can e.g. increase volume and a push button click on the left instrument can reduce volume. Such schemes are illustrated in FIGS. 2b and 2c.

Optionally, the binaural listening system is adapted to provide that the manually operable activation element has more than one mode of operation, where each mode of operation influences a different part of the functionality of the listening system. Preferably, the system is adapted to provide that corresponding manually operable activation elements of the two listening devices of a system are in the same mode of operation at a given time, e.g. both associated with level or volume control of the output transducer.

Other functionality associated with the activation element can e.g. be program selection. In an embodiment, comprising two programs or two groups of programs, one program (or group) is e.g. selected by the left instrument, the other program (or group) being e.g. selected by the right instrument. In case of more than one program in a group, the system is e.g. adapted to provide that the activation element of a given instrument can toggle through the group of programs associated with that instrument. In a preferred embodiment, each hearing instrument comprises a predefined number Np of programs P₁, P₂, . . . , P_{q-1}, P_{q}, P_{q+1}, P_{Np}. In an embodiment, the activation of the activation element in a program setting mode of a first hearing instrument of a binaural listening system, where the current program is P_{q}, changes the program to the program with next following index P_{q+1}. Correspondingly, the activation of the activation element in a program setting mode of the second hearing instrument of the binaural listening system, where the current program is P_{q}, changes the program to the program with previous index P_{q-1}. Such scheme is illustrated in FIG. 2a, where Activation #1-5 of the activation element on the 1^{st} listening device (1^{st} LD in FIG. 2a) results in Program shifts from P4->P1->P2->P3->P4->P1 (assuming that Np=4 programs P1-P4 are available for selection by a user and that the system starts out with both instruments having P4 active before activation 1). Each activation results in the consequent program change to be transferred from the 1^{st} to the 2^{nd} listening device via the wireless link between them (as indicated by arrows → in column Tx). Activations 6-10 of the activation element on the 2^{nd} listening device (2^{nd} LD in FIG. 2a) results in program shifts from P1->P4->P3->P2->P1->P4. Each activation results in the consequent program change to be transferred from the 2^{nd} to the 1^{st} listening device via the wireless link between them (as indicated by arrows <← in column Tx). As indicated in FIG. 2a, the program shifts resulting from a sequential activation the activation element of either of the two listening devices of the binaural listening system a number of times larger than or equal to the number Np of programs (P1, P2, . . . PNp) results in a sequential cyclic selection of all programs either in ascending (1^{st} LD) or descending (2^{nd} LD) order.

Alternatively or additionally, the system is adapted to provide that an activation element is in a mode for selection between an input from an input transducer (e.g. a microphone) and from one or more direct electric inputs. In an embodiment, the activation element of the right listening device selects a microphone input, when the activation element is in an input selection mode, and the activation element of the left listening device selects a direct electric input (e.g. a T-coil or other electric input).

Alternatively or additionally, the system is adapted to provide that an activation element is in a mode for selection between a directional and an omni-directional mode of operation. In an embodiment, the activation element of the right listening device selects a directional input state, when the activation element is in a microphone system state selection mode, and the activation element of the left listening device selects an omni-directional state.

Preferably, the system is adapted to provide that the modes of operation of the activation element can be selected by the user, e.g. by means of the activation element itself, e.g. by implementing a short, medium and long activation times (e.g. push button clicks) to be used to activate different modes of operation of the activation element, such as volume up/down, program activation element and mute/normal, respectively.

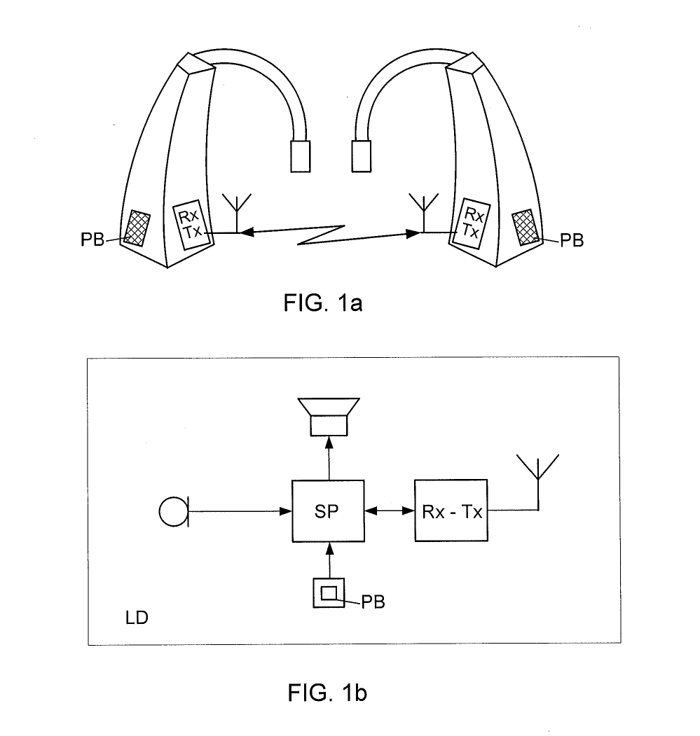

FIG. 1 shows an exemplary binaural listening system comprising two wirelessly connected listening devices (FIG. 1a) and an exemplary listening device (FIG. 1b).

FIG. 1a shows a binaural hearing aid system comprising first and second hearing instruments adapted for being located at or in left and right ears, respectively, of a person during use of the hearing aid system (the hearing instruments here shown to be of the behind the ear (BTE) type). Each hearing instrument comprises antenna (cf. antenna symbol) and transceiver circuitry (Rx-Tx) for establishing bidirectional communication with the opposite hearing instrument during use of the system, at least for exchanging control information with the aim of synchronizing operational parameter settings. Additionally, the hearing instruments may also be able to exchange audio signals in part or in full. Additionally or alternatively, one or both hearing instruments of the binaural system may comprise circuitry for receiving a direct electric input, e.g. antenna and transceiver circuitry for wirelessly receiving an audio signal from an audio delivery device (e.g. from a microphone or a telephone or an entertainment device, e.g. a music player). Each hearing instrument comprises a manually operable activation element (here in the form of push button PB) for influencing the functionality of the hearing aid system in one or more modes, wherein the effect of activation of the activation element of one of the hearing instruments in a first mode (e.g. a volume setting) is different (e.g. volume up) from the effect of activation of the activation element of the other hearing instrument (e.g. volume down) in the same first mode. Using the wireless link between the two devices, the binaural listening system is e.g. adapted to provide that the effect of activation of the activation element of one of the listening devices is to increase the volume setting of both listening devices and the effect of activation of the activation element of the other listening device is to decrease the volume setting of both listening devices.

The user operable activation element can be of any appropriate kind depending on the application and can e.g. be a push button activation element (e.g. PB100 from Sonion A/S, Roskilde, Denmark) or a toggle activation element (e.g. a two position toggle activation element, e.g. SW96 from Sonion). The wireless link between the two listening devices may e.g. be implemented as a near-field communication system, e.g. based on inductive coupling between antenna coils located in the respective listening devices. Such system is e.g. described in US 2005/0255843 A1. Alternatively, the link may be based on radiated fields, e.g. digitally modulated according to the Bluetooth standard.

FIG. 1b shows functional elements of a listening device (LD), here a hearing instrument, of a binaural hearing aid system as shown in FIG. 1a. The hearing instrument comprises a microphone (cf. microphone symbol) for picking up an acoustic signal from the environment and converting it to an electric input signal, a signal processing unit (SP) for processing the electric input signal and providing a processed output signal and an output transducer (cf. receiver/speaker symbol) for converting the processed output signal to an acoustic sound for being presented to a user. The hearing instrument further comprises antenna (cf. antenna symbol) and transceiver circuitry (Rx-Tx) at least for establishing bidirectional communication (e.g. control or status signals) with another corresponding hearing instrument. The hearing instrument further comprises a user operable activation element (e.g. a push button, PB) for influencing the functionality of the hearing aid system in one or more modes of the system. The control of the manual inputs to the hearing instrument from the user operable activation element and the transfer of control signals to the opposite hearing instrument of the binaural hearing aid system as a consequence of the user input are governed by the signal processing unit. Relations between the different modes of operation of the manually operable activation element and the consequence of the (possibly different) activation(s) of the activation element are stored in a memory of the listening device. The relations may be customized from a programming device (e.g. using a wireless interface in the listening device), e.g. during an initial (or later) adaptation or fitting of the listening device to the current user.

FIGS. 2b and 2c show examples of two different volume change schemes for a binaural listening system, one with equal steps up and down (FIG. 2b) and one with larger steps down than up (FIG. 2c).

In FIG. 2b, a scheme for changing volume in equal steps up and down is illustrated. Activation#1-4 of the activation element on the 1^{st} listening device (1^{st} LD in FIG. 2b) results in Volume lvl shifts from L1->L2->L3->L4->L4 (assuming that 4 volume levels L1-L4 are available for selection by a user and that the system starts out with both instruments having level L1 active before activation 1 of the 1^{st} LD). Each activation results in the consequent level change to be transferred from the 1^{st} to the 2^{nd} listening device via the wireless link between them (as indicated by arrows → in column Tx). Activations 6-9 of the activation element on the 2^{nd} listening device (2^{nd} LD in FIG. 2b) results in volume level shifts from L4->L3->L2->L1->L1. Each activation results in the consequent level change to be transferred from the 2^{nd} to the 1^{st} listening device via the wireless link between them (as indicated by arrows ← in column Tx). It appears from FIG. 2b that the volume levels cannot be increased and decreased, respectively above and below levels L4 and L1, respectively in that repeated activation of the activation element on the 1^{st} LD when the volume level is already at the highest level has no effect (the volume level remains at its maximum level, here L4). Similarly, a repeated activation of the activation element on the 2^{nd} LD when the volume level is already at the lowest level has no effect (the volume level remains at its minimum level, here L1). Any number of volume levels between a minimum value (e.g. mute or a finite low volume level) and a maximum value can be implemented according to the application in question. The minimum and maximum values are preferably adapted to the user's needs (e.g. a hearing impairment), either by the user him- or herself or during a fitting process.

In FIG. 2c, a scheme for changing volume is illustrated where the steps are larger when volume is decreased than when volume is increased. The scheme is similar to the one shown in FIG. 2b, but in the scheme of FIG. 2c volume is regulated up between a minimum level L1 and a maximum level L8 in 7 steps by Activation#1-7 of the first LD and regulated down from the maximum level L8 to the minimum level L1 in 4 steps by Activation#9-12 of the 2^{nd} LD. The down regulation from maximum (L8) to minimum (L1) volume is provided from L8 via L6, L4 and L2. In the shown embodiment, volume is initially regulated down from the maximum value by two steps and finally from L2 to L1 in on step. Any number of steps can of course be implemented. And the down-steps need not have any relation to the up-steps (as here) and need not be equal in size, but may e.g. be progressively lower from a largest first step (from the maximum level (L8)) to a smallest last step to the minimum level (L1). In an embodiment, only the step from the maximum level and down is larger than the other down-steps. In an embodiment, the first two steps down from the maximum level are larger than the other down-steps. As also indicated in FIG. 2b, the system is preferably adapted to provide that a repeated activation of the activation elements attempting to increase or decrease, respectively, the volume when a maximum or minimum level, respectively, has already been reached has no effect (cf. Activation#8 of the 1^{st} LD and Activation#13 of the 2^{nd} LD, respectively). In an embodiment, an acoustic or tactile indication is provided to the user when such ineffective activation is performed.

In the schemes of FIG. 2, the activations of the activation elements of the respective 1^{st} and 2^{nd} listening devices are shown to be sequentially on the 1^{st} and 2^{nd} devices (i.e. first a number of activations of the activation element of the 1^{st} device and subsequently a number of activations of the activation element of the 2^{nd} device). This, of course, need be the case. In a normal operation the activation of activation elements of the 1^{st} and 2^{nd} listening devices is distributed so that activation shifts between the two devices.

The invention is defined by the features of the independent claim(s). Preferred embodiments are defined in the dependent claims. Any reference numerals in the claims are intended to be non-limiting for their scope.

Some preferred embodiments have been shown in the foregoing, but it should be stressed that the invention is not limited to these, but may be embodied in other ways within the subject-matter defined in the following claims. In the examples above, the listening devices are embodied in BTE hearing instruments. Any other form of hearing instruments, e.g. of the in the ear (ITE) type adapted to be located fully or partially in an ear canal of the user can just as well be used. Likewise, a binaural listening system may just as well comprise a binaural cochlear implant hearing aid system or a binaural bone conducting hearing aid system comprising parts located at an ear of a user may where an activation element may be used in the manner described above. In general, any listening system comprising two devices adapted for being worn by a user and which are intended to operate in some sort of synchrony can benefit from the teaching of the present disclosure, e.g. a pair of headphones, e.g. including active protection against a surrounding sound environment.

### REFERENCES

US 2004/0208332 A1 (PHONAK) Oct. 21, 2004
WO 2008/006772 A2 (PHONAK) Jan. 1, 2008
EP 0 941 014 A2 (SIEMENS AUDIOLOGISCHE TECHNIK) Sep. 8, 1999
US 2005/0255843 A1 (Hilpisch et al.) Nov. 17, 2005

1. A binaural listening system comprising first and second listening devices adapted for being located at or in left and right ears, respectively, of a person during use of the listening system, each listening device comprising antenna and transceiver circuitry for establishing a bidirectional wireless link to the opposite listening device during use of the system, each listening device comprising a manually operable activation element for influencing the functionality of the listening system in a predefined way, the manually operable activation element having at least one mode of operation, wherein
the system is adapted to provide that the effect on functionality of a specific activation of the manually operable activation element of the first listening device is different from the effect of the same specific activation of the corresponding manually operable activation element of the second listening device.

2. A binaural listening system according to claim 1 wherein a control signal representing the effect of the activation of the activation element of the first listening device is transferred via said wireless link to the second listening device for implementing the same effect in that listening device and vice versa.

3. A binaural listening system according to claim 1 adapted to provide that said manually operable activation element has at least two modes of operation, where each mode of operation influences a different part of the functionality of the listening system.

4. A binaural listening system according to claim 1 wherein the system is adapted to provide that the activation elements of the first and second listening devices can be set in different modes of operation at a given point in time.

5. A binaural listening system according to claim 1 wherein the system is adapted to provide that the effect on functionality of a specific activation of the manually operable activation element of the first listening device in a given mode of operation of the manually operable activation element is different from the effect of the same specific activation of the corresponding manually operable activation element of the second listening device in the same given mode of operation of the manually operable activation element.

6. A binaural listening system according to claim 1 adapted to provide that said manually operable activation element in a mode of operation changes the volume setting.

7. A binaural listening system according to claim 6 adapted to provide that the effect of activation of the activation element of one of the listening devices is to increase the volume setting of both listening devices and the effect of activation of the activation element of the other listening device is to decrease the volume setting of both listening devices.

8. A binaural listening system according to claim 1 adapted to provide that said manually operable activation element in a mode of operation changes the program setting.

9. A binaural listening system according to claim 8 wherein the effect of activation of the manually operable activation element of one of the listening devices is to select the next listening program for both listening devices and the effect of activation of the manually operable activation element of the other listening device is to select the previous listening program for both listening devices.

10. A binaural listening system according to claim 1 adapted to provide that different modes of operation of the manually operable activation element can be selected by activating the manually operable activation element for different durations of time, e.g. relatively short and relatively long durations of time.

11. A binaural listening system according to claim 1 adapted to provide that the different modes of operation of the manually operable activation element and/or the effects of activation of the manually operable activation element in a given manner in a given mode on the individual hearing instruments of the binaural listening system can be set during fitting of the system, e.g. according to a particular user's needs and/or wishes.

12. Use of a binaural listening system according to claim 1.

13. A method of operating a binaural listening system, the binaural listening system comprising first and second listening devices adapted for being located at or in left and right ears, respectively, of a person during use of the listening system, each listening device comprising antenna and transceiver circuitry for establishing a bidirectional wireless link with the opposite listening device during use of the system, each listening device comprising a manually operable activation element for influencing the functionality of the listening system in a predefined way, the manually operable activation element having at least one mode of operation, the method comprising
providing that the effect on functionality of a specific activation of the manually operable activation element of the first listening device is different from the effect of the same specific activation of the corresponding manually operable activation element of the second listening device.

14. A method according to claim 13 comprising providing that a control signal representing the effect of the activation of the activation element of the first listening device is transferred via said wireless link to the second listening device for implementing the same effect in that listening device and vice versa.

15. A method according to claim 13 comprising providing that said manually operable activation element has at least one mode of operation, such as two or more, where each mode of operation influences a different part of the functionality of the listening system.
